(19) United States
(12) Patent Application Publication
(10) Pub. No.: US 2024/0424451 A1
(43) Pub. Date: Dec. 26, 2024

(54) COMPOSITIONS AND METHODS FOR SELECTIVE EXTRACTION OF LITHIUM

(71) Applicant: THE REGENTS OF THE UNIVERSITY OF CALIFORNIA, Oakland, CA (US)

(72) Inventors: David Jassby, Los Angeles, CA (US); Eric M. Hoek, Los Angeles, CA (US); Jingbo Wang, Los Angeles, CA (US); Gaurav N. Sant, Los Angeles, CA (US)

(21) Appl. No.: 18/708,430

(22) PCT Filed: Nov. 7, 2022
(86) PCT No.: PCT/US22/49102

§ 371 Date: May 8, 2024

Related U.S. Application Data
(60) Provisional application No. 63/276,921, filed on Nov. 8, 2021.

(51) Int. Cl. B01D 69/14; B01D 61/44; B01D 67/00; B01D 69/02

(52) U.S. Cl. CPC B01D 69/148; B01D 61/44; B01D 67/00793; B01D 69/02; B01D 2323/081; B01D 2323/12; B01D 2323/219; B01D 2323/48; B01D 2325/14

(57) ABSTRACT

Provided herein are ion-selective separation membranes including a polymer matrix and a metal compound dispersed within the polymer matrix. The metal compound includes HₐLi_{b}X_{c}Oₐ, where a is from 1 to 1.5, b is from 0 to 0.1, c is from 1 to 2, d is from 4 to 4.5, and X includes manganese or titanium.

### CROSS-REFERENCE TO RELATED APPLICATIONS

This application claims the benefit of priority to U.S. Provisional Application No. 63/276,921, filed on Nov. 8, 2021, the contents of which are hereby incorporated by reference in their entirety.

### STATEMENT OF GOVERNMENT SUPPORT

This invention was made with Government support under Grant No. DE-EE0008391 awarded by the Department of Energy. The Government has certain rights in the invention.

### FIELD OF THE INVENTION

Embodiments of the present disclosure generally relate to membranes for the selective extraction of a monovalent metal ion. More specifically, the present disclosure relates to membranes for the selective extraction of lithium ions from a brine solution.

### BACKGROUND

Lithium compounds are key components in many commercial applications including batteries, glass, ceramics, lubricating greases, and other industrial products. Global lithium consumption has significantly increased in the recent decades and is projected to reach 0.2 million tons by 2030. Lithium resources mainly exist in solid form (e.g., minerals ores and recycled lithium-ion batteries) and liquid form (e.g., seawater and other lithium-rich brines). Current commercial lithium production mostly relies on continental brine sources. The mainstream lithium extraction techniques, such as evaporation-precipitation process and solvent extraction, have shown to be costly, time-consuming, and non-eco-friendly. Recent developments in membrane-based separation technology have provided a promising and environmentally friendly alternative for lithium recovery.

Membrane separation has the advantages of high energy efficiency, scalability, and easy operation in a continuous process. For example, nanofiltration (NF) can extract monovalent ions with the mechanisms of Donnan exclusion, dielectric exclusion, and steric hindrance. NF is a membrane liquid-separation technology sharing many characteristics with reverse osmosis (RO). However, unlike RO, which has high rejection of virtually all dissolved solutes, NF provides high rejection of multivalent ions, such as sulfate, and low rejection of monovalent ions, such as chloride.

Membrane distillation crystallization can recover minerals from hypersaline brine using low-grade heat and selective electrodialysis can efficiently separate the monovalent cations under the electric field. While the above membrane processes offer bulk salt separation capabilities to some extent, the above processes do not provide a cation-specific selective membrane, especially between lithium and other monovalent cations due to the presence of multiple concentrated competing cations in brines.

Lithium ion sieves (LIS) have been fabricated into adsorption media for lithium extraction, but the adsorption-desorption process can be operated only in a batch mode. LIS as known in the art are described in Xu et al., “Extraction of lithium with functionalized lithium ion-sieves.” Progress in Materials Science. Vol 84. December 2016, Pages 276-313. The slow adsorption rates also result in inefficiencies in lithium extraction, and thus limit large scale application of this process relative to a continuous mode. Accordingly, there exists a need for improved materials and processes for selective lithium ion extraction.

### SUMMARY OF THE INVENTION

In various embodiments, an ion-selective separation membrane includes a polymer matrix and a metal compound dispersed within the polymer matrix. The metal compound includes HₐLi_{b}X_{c}O_{d}, where a is from 1 to 1.5, b is from 0 to 0.1, c is from 1 to 2, d is from 4 to 4.5, and X includes manganese or titanium.

In various embodiments, a method of preparing an ion-selective separation membrane is disclosed where a lithium manganese oxide or a lithium titanium oxide is provided. The lithium manganese oxide or the lithium titanium oxide is delithiated to obtain a lithium adsorbent. The lithium adsorbent is dispersed in a polymer matrix to form a polymer-adsorbent mixture. The polymer-adsorbent mixture is heated to thereby obtain the synthesized ion-selective separation membrane.

In various embodiments, a method of selectively separating ions in a polar solution comprising a plurality of ions is disclosed where an ion-selective separation membrane is provided. The polar solution is contacted with the ion-selective separation membrane. An electrical potential difference is applied across the ion-selective separation membrane to selectively transport target ions through the membrane.

In various embodiments, an ion-selective separation membrane is provided including a polymer matrix having a polymer backbone and one or more functional groups and a metal ion adsorbent dispersed within the polymer matrix. The metal ion adsorbent is configured to allow transport a target ion through the membrane and block passage of one or more non-target ions upon application of an electric potential difference across the membrane.

### BRIEF DESCRIPTION OF THE SEVERAL VIEWS OF THE DRAWINGS

FIG. 1 illustrates a casted anion exchange membrane (AEM) without lithium adsorbent particles in accordance with an embodiment of the present disclosure.

FIG. 2 illustrates a casted AEM with lithium adsorbent particles in accordance with an embodiment of the present disclosure.

FIG. 3 illustrates a graph of specific ion flux of feed A in accordance with an embodiment of the present disclosure.

FIG. 4 illustrates a graph of specific ion flux of feed B in accordance with an embodiment of the present disclosure.

FIG. 5 illustrates an apparatus for excluding lithium using an ion-selective separation membrane in accordance with an embodiment of the present disclosure.

### DETAILED DESCRIPTION

The present invention advantageously integrates a highly lithium-selective material into a continuous membrane system, thereby providing a method for effective lithium extraction from complex aqueous solutions, such as geothermal brines, acid extracting solutions in battery recycling operations, etc. The highly lithium-selective material is capable of excluding multivalent and certain monovalent cations, while allowing a target monovalent cation (e.g., lithium) to pass through.

More particularly, disclosed herein are ion selective separation membranes for separating a target metal ion from other cations, such as a target monovalent cation from other multivalent metal ions or monovalent metal ions (e.g., Na⁺). Additionally, disclosed herein are methods of synthesizing ion selective separation membranes and methods of separating ions using the ion selective separation membrane. In various embodiments, an ion sieve material is synthesized by introducing target ions (e.g., lithium) into an inorganic compound (e.g., a metal oxide) by a redox or ion exchange reaction. The synthesized ion sieve material includes a crystal structure with the target ions integrated therein. The target ions, after being incorporated into the crystal structure, are eluted out of the crystal positions by an eluent, and the ion sieve material retains the vacant crystal sites of the target ion thereby only allowing passage of the target ion (or ions having a smaller ionic radii). In various embodiments, where lithium is the target ion, only lithium ions can pass through the vacant crystal positions because lithium has the smallest ion radius compared to other cations. In various embodiments, the ion sieve material is combined with a polymer matrix, such as by dispersion or mixing.

In various embodiments, an ion exchange membrane includes a polymer matrix (e.g., a polymer backbone) having one or more functional groups that provide fixed-charge sites. In various embodiments, the polymer matrix includes any one the following: methacrylamide, polyaromatic, styrene-divinylbenzene copolymer, polyester, poly(vinylchloride), poly(ethylene), poly(propylene), polystyrene, polystyrene-divinylbenzene copolymer, fluorinated interpenetrating polymer network, low density poly(ethylene)/high density poly(ethylene) (interpenetrating polymer network), polystyrene-block-ethylene butylene-block-polystyrene, polystyrene/butadiene, polyethylene oxide, alkoxysilane-functionalized polyethylene oxide, alkoxysilane-functionalized polyvinyl alcohol, poly(epichlorohydrin-co-ethylene oxide), polyvinyl alcohol, poly(epichlorohydrin), polyacrylic acid, chitosan, polybenzimidazole, glycidyl methacrylate, 3-(methacryloxypropyl) trimethoxysilane, alkoxysilane/acrylate, epoxy alkoxysilane, poly(vinylbenzyl chloride), poly(phenylene oxide), poly(methyl acrylate), polyethyleneimine, poly(1,1-dimethyl-3,5-dimethylenepiperidinium chloride), poly(diallyldimethylammonium chloride), poly(allyl amine), poly(acrylonitrile-co-2-dimethylaminoethylmethacrylate), polychloromethylstyrene, poly(divinylbenzene), norbonene/dicyclopentadiene, cyclooctene, poly(phenylene), poly(methyl methacrylate), poly(butyl-acrylate), poly(methyl methacrylate-co-butyl-acrylate-co-vinyl benzyl), polyvinyl butyral, polyvinylidene fluoride, ethylene tetrafluoroethylene, fluorinated ethylene propylene, polytetrafluoroethylene, poly(4-vinylpyridine), polystyrene-ethylene-butylene sulfonate copolymer, epichlorohydrin/1,4-diazabicyclo[2.2.2]octane, polyethylene glycol, polysulfone, polyethersulfone Cardo, poly(phthalazinone ether sulfone ketone), polysulfonepolyphenylenesulfidesulfone, polyarylene, polydiallyldimethylammonium chloride, poly(ether imide), and/or sulfonated tetrafluoroethylene based fluoropolymer-copolymer.

In various embodiments, the functional group includes a nitrogen-containing group, such as quaternary ammonium, tertiary diamines, (benz) imidazolium, guanidinium, and/or pyridinium. In various embodiments, the functional group includes a nitrogen-free group, such as phosphonium, sulphonium, ruthenium, nickel, and/or cobalt.

In terms of specific ion selectivity, LIS has shown satisfying performance as a group of ion adsorbent material because of the “ion-sieve effect”. As described above, ion-sieve materials are synthesized by introducing target ions into an inorganic compound by redox or ion exchange reaction. The target ions are eluted from their crystal positions by eluent, retaining vacancy crystal sites which could only accommodate the template ions, or the ions that have smaller ionic radii. For LIS, lithium ions selectively access the vacancy because it has a smaller ionic radius compared to competing cations, such as Na⁺, K⁺, Rb⁺, Cs⁺, Mg²⁺, Ca²⁺.

In general, LIS materials include lithium manganese oxides (LMO) and lithium titanium oxides (LTO). In various embodiments, a LMO includes a lithium manganese oxide (e.g., LiMn₂O₄, Li₂MnO₃, LiMnO₂, Li₂MnO₂). In various embodiments, a LTO includes lithium titanate (Li₂TiO₃). In comparison, the LMO-type of LIS has a higher lithium selectivity and adsorption capacity, while the LTO-type of LIS has a lower dissolution loss and better recyclability.

In various embodiments, high lithium-selective material may be integrated into a continuous membrane system to provide an approach for effective lithium extraction from a brine source (e.g., a polar solvent with lithium and one or more other metal ions dissolved therein). In preferred embodiments, the solvent is water.

In some embodiments, the brine source is a continental brine, a geothermal brine, or an oil field brine. Continental brine deposits are found in underground reservoirs, typically in locations with arid climates. The brines are contained within a closed basin, with the surrounding rock formations being the source of the dissolved constituents in the brine. Geothermal brine deposits are found in rocky underground formations with high heat flows. Geothermal brines may be highly concentrated, often with significant dissolved metal content. Oil field brine deposits may be generated from lands with underground petroleum reserves. In extracting oil and gas from oil fields, a significant amount of brine is also brought to the surface as well. These brines are often rich in dissolved metals, which can include lithium in some locations.

In various embodiments, the polar solution contains Li ions and at least one additional cation. In various embodiments, the additional cation is a monovalent cation, a divalent cation, or a combination thereof. In various embodiments, the monovalent cation is an alkali metal ion (e.g., one or more of Na⁺, K⁺, Rb⁺, Cs⁺). In some embodiments, the multivalent ion is a divalent ion. In certain such embodiments, the divalent ion is an alkaline earth metal ion, such as Ca²⁺ or Mg²⁺.

In various embodiments, the ion-selective separation membrane includes any suitable embedded particles (e.g., ions) that foster specific interactions with the target metal ions (e.g., monovalent ions). In various embodiments, the ion-selective separation membrane is formed with any suitable adsorbent (e.g., a metal ion adsorbent) that is configured to allow transport of target ions through the membrane under the influence of an applied electric potential difference while non-target ions are not able (e.g., are too large) to pass through the membrane. In various embodiments, the target ion includes at least one of: an alkali metal (lithium, sodium, potassium, rubidium, cesium, francium), an alkaline earth metal (beryllium, magnesium, calcium, strontium, barium, radium), a transition metal (scandium, titanium, vanadium, chromium, manganese, iron, cobalt, nickel, copper, zinc, yttrium, zirconium, niobium, molybdenum, technetium, ruthenium, rhodium, palladium, silver, cadmium, lutetium, hafnium, tantalum, tungsten, rhenium, osmium, iridium, platinum, gold, mercury, lawrencium, rutherfordium, dubnium, seaborgium, bohrium, hassium, meitnerium, darmstadtium, roentgenium, copernicium), a post-transition metal (aluminum, gallium, indium, tin, thallium, lead, bismuth, nihonium, flerovium, moscovium, livermorium, tennessine, oganesson), a lanthanide (lanthanum, cerium, praseodymium, neodymium, promethium, samarium, europium, gadolinium, terbium, dysprosium, holmium, erbium, thulium, ytterbium, lutetium), an actinide (actinium, thorium, protactinium, uranium, neptunium, plutonium, americium, curium, berkelium, californium, einsteinium, fermium, mendelevium, nobelium, lawrencium), and/or a superactinide.

In various embodiments, the ion-selective separation membrane selectively separates a target monovalent ion from a polar solution containing the target ion and at least one competing ion. In various embodiments, the competing ion may be another monovalent ion such as Na⁺, K⁺, Rb⁺, Cs⁺, a divalent ion such as Ca²⁺ or Mg²⁺, or any combination of mono- and divalent ions.

In various embodiments, the selectivity for the target monovalent ions over the competing ions is at least 1.1. In various embodiments, the selectivity for the target monovalent ions over the competing ions is at least 2. In various embodiments, the selectivity for the target monovalent ions over the competing ion is at least 5. In various embodiments, the selectivity for the monovalent ions over the competing ions is at least 10. In various embodiments, the selectivity for the monovalent ions over the competing ion is at least 50. In various embodiments, the selectivity for the monovalent ions over the competing ions is at least 100. In various embodiments, the selectivity for the monovalent ions over the competing ions is at least 200. In various embodiments, the selectivity for the monovalent ions over the competing ion is at least 1,000. In various embodiments, the selectivity for the monovalent ions competing ions is at least 2,000. In various embodiments, the selectivity for the monovalent ions over the competing ions is at least 5,000. In various embodiments, the selectivity for the monovalent ions over the competing ions is at least 10,000. In various embodiments, the selectivity for the monovalent ions over the competing ions is at least 100,000.

In various embodiments, the target monovalent ion is one or more metal cations selected from the group consisting of Li⁺, Na⁺, K⁺, Rb⁺, Cs⁺, Ca⁺², Mg⁺², Sr⁺², Fe⁺², Mn⁺², Ni⁺², Fe⁺³, Al⁺³. In various embodiments, the target monovalent ion is Lit. In various embodiments, the target ion is one of the alkali metals, or a member of the alkaline earth metals, transition metals, post-transition metals, lanthanides, actinides, or superactinide family. In various embodiments, the competing ions include one or more metal cations selected from the group consisting of: Na⁺, K⁺, Rb⁺, Cs⁺, Ca⁺², Mg⁺², Sr⁺², Fe⁺², Mn⁺², Ni⁺², Fe⁺³, Al⁺³.

In some embodiments, the proposed process includes the following steps:

Step 1. Prepare LIS adsorbent material. In various embodiments, a lithium manganese oxide (LMO) or lithium titanium oxide (LTO) is prepared by heat treating a first material at a predetermined temperature.

Where a LMO is being prepared, the first material may be LiMnO₂. In various embodiments, the predetermined temperature may be about 350° C. to about 600° C. In various embodiments, the predetermined temperature may be about 450° C. In various embodiments, heat treating may be conducted in atmospheric air. In various embodiments, heat treating may be conducted in a specific gaseous environment, such as an environment devoid of oxygen (e.g., nitrogen environment).

In various embodiments, the LMO or LTO is delithiated to thereby remove most (e.g., substantially all) lithium ions from the resulting crystal structure. In various embodiments, delithiating the LMO or LTO is conducted via Li⁺/H⁺ exchange. In various embodiments, the LIS adsorbent material is delithiated for a period of 1 hour to 24 hours. In various embodiments, the LIS adsorbent material is delithiated for a period of at least 24 hours. In various embodiments, the LIS adsorbent material is dispersed in an aqueous solution of a strong acid (e.g., HCl). In various embodiments, the mole ratio of proton (provided by the acid) and target metal ion (e.g., lithium in LMO) is at least 50. In various embodiments, the resulting material is a target ion (e.g., lithium) adsorbent. For example, the resulting adsorbent may include a chemical formula of HₐLi_{b}X_{c}O_{d} (HMO). In various embodiments, the resulting particles are washed with deionized water until the waste water has a neutral pH. In various embodiments, the resulting particles are dried between 30° C. and 80° C. in an oven. In various embodiments, X is manganese or titanium. In various embodiments, a is from 0 to 10, b is from 0 to 10, c is from 0 to 10, and d is from 0 to 10. In various embodiments, a is from 0.5 to 2, b is from 0 to 0.2, c is from 0.5 to 5, and d is from 1 to 6. In various embodiments, a is from 1 to 1.5, b is from 0 to 0.1, c is from 1 to 2, and d is from 4 to 4.5. In various embodiments, a is from 1 to 1.2, b is from 0.07 to 0.09, c is from 1.6 to 1.8, and dis from 4 to 4.2. In various embodiments, a is about 1.1, b is about 0.8, c is about 1.73, and d is about 4.05. In certain embodiments, b is from greater than 0 to about 0.1.

Step 2. Disperse LIS particles into polymer solution. In various embodiments, the resulting particles were dispersed in an ionomer solution composed of any of the polymer backbone and functional group combinations listed above. In some manifestations, HMO particles were dispersed in a poly(p-phenylene oxide) backbone functionalized with quaternary ammonium groups ionomer solution at a certain mass ratio by sonicating, stirring, or sheer mixing the mixture for about 30 seconds to about an hour (e.g., 30 seconds, 60 seconds, 10 minutes, or 1 hour) in an ice bath. In various embodiments, membranes are loaded with the resulting particles (e.g., HMO particles) at loading ranging of about 1% to about 50% (corresponding HMO-polymer mass ratio ranging between 0.1:1 to 0.5:1).

In various embodiments, the resulting lithium adsorbent material is mixed in a predetermined ratio with a polymer matrix. In various embodiments, the adsorbent material may be about 0.10% to about 75% by weight (an adsorbent to polymer ratio of about 1:999 to about 3:1) of the combined polymer-adsorbent mixture. In various embodiments, the adsorbent material may be about 1% to about 75% by weight (an adsorbent to polymer ratio of about 1:99 to about 3:1) of the combined polymer-adsorbent mixture. In various embodiments, the adsorbent material may be about 5% to about 75% by weight (an adsorbent to polymer ratio of about 1:19 to about 3:1) of the combined polymer-adsorbent mixture. In various embodiments, the adsorbent material may be about 1% to about 50% by weight (an adsorbent to polymer ratio of about 1:99 to about 2:1) of the combined polymer-adsorbent mixture. In various embodiments, the adsorbent material may be about 25% to about 50% by weight (an adsorbent to polymer ratio of about 1:3 to about 2:1) of the combined polymer-adsorbent mixture. In various embodiments, the adsorbent material may be at least 1% by weight of the combined polymer-adsorbent mixture. In various embodiments, the adsorbent material may be about 5% by weight of the combined polymer-adsorbent mixture. In various embodiments, the adsorbent material may be about 10% by weight of the combined polymer-adsorbent mixture. In various embodiments, the adsorbent material may be about 15% by weight of the combined polymer-adsorbent mixture. In various embodiments, the adsorbent material may be about 20% by weight of the combined polymer-adsorbent mixture. In various embodiments, the adsorbent material may be about 25% by weight of the combined polymer-adsorbent mixture. In various embodiments, the adsorbent material may be about 30% by weight of the combined polymer-adsorbent mixture. In various embodiments, the adsorbent material may be about 35% by weight of the combined polymer-adsorbent mixture. In various embodiments, the adsorbent material may be about 40% by weight of the combined polymer-adsorbent mixture. In various embodiments, the adsorbent material may be about 45% by weight of the combined polymer-adsorbent mixture. In various embodiments, the adsorbent material may be about 50% by weight of the combined polymer-adsorbent mixture. In various embodiments, the adsorbent material may be about 55% by weight of the combined polymer-adsorbent mixture. In various embodiments, the adsorbent material may be about 60% by weight of the combined polymer-adsorbent mixture. In various embodiments, the adsorbent material may be about 65% by weight of the combined polymer-adsorbent mixture. In various embodiments, the adsorbent material may be about 70% by weight of the combined polymer-adsorbent mixture. In various embodiments, the adsorbent material may be about 75% by weight of the combined polymer-adsorbent mixture.

In various embodiments, the polymer-adsorbent mixture may be mixed via an external device, such as a sonicator. In various embodiments, the polymer-adsorbent mixture may be mixed in an ice bath. In various embodiments, the polymer-adsorbent mixture may be mixed for up to a minute (e.g., 30 seconds).

Step 3. Fabricate mixed matrix membrane (MMM) from LIS-polymer solution. In various embodiments, the polymer-adsorbent mixture may be heated to thereby evaporate solvent from the polymer-adsorbent mixture and to obtain the synthesized ion-selective separation membrane. In various embodiments, the polymer-adsorbent mixture is heated at a temperature of about 50° C. to about 100° C. In various embodiments, the polymer-adsorbent mixture is heated at a temperature of 80° C. In various embodiments, the polymer-adsorbent mixture is heated for about 1 hour to about 24 hours. In various embodiments, the polymer-adsorbent mixture is heated for about 20 hours. In various embodiments, the synthesized ion-selective separation membrane may be soaked in a test solution (e.g., brine solution) prior to use. In various embodiments, the synthesized ion-selective separation membrane may be soaked in deionized (DI) water prior to use.

Step 4. Apply a driving force (e.g., an electrical potential, concentration or pressure difference) to the MMM system for continuous lithium extraction from brines. In various embodiments, the electrical potential difference can be from about 10 mV to about 1 V. In various embodiments, the rate of ion transport through the membrane is a function of the electrical potential difference applied across the membrane. In various embodiments, increasing the electrical potential difference increases the rate of select ion transport through the ion-selective separation membrane. In various embodiments, decreasing the electrical potential difference decreases the rate of select ion transport through the ion-selective separation membrane.

In various embodiments, the applied electrical potential difference is at least 12 mV. In various embodiments, the applied electrical potential difference is at least 14 mV. In various embodiments, the applied electrical potential difference is at least 16 mV. In various embodiments, the applied electrical potential difference is at least 18 mV. In various embodiments, the applied electrical potential difference is at most 1.8 V. In various embodiments, the applied electrical potential difference is at most 1.6 V. In various embodiments, the applied electrical potential difference is at most 1.4 V. In various embodiments, the applied electrical potential difference is at least 1.2 V. In various embodiments, the applied electrical potential difference is at least 1V. In various embodiments, the applied electrical potential difference is at least 1 V. In various embodiments, the applied electrical potential difference is at least 2 V. In various embodiments, the applied electrical potential difference is at least 5 V. In various embodiments, the applied electrical potential difference is at least 50 V. In various embodiments, the applied electrical potential difference is at most 1.5 V. In various embodiments, the applied electrical potential difference is at most 2 V. In various embodiments, the applied electrical potential difference is at most 5 V. In various embodiments, the applied electrical potential difference is at least 10 V. In various embodiments, the applied electrical potential difference is at least 50 V.

In various embodiments, the current density associated with the applied electrical potential difference may be at least 0.1 A/m². In various embodiments, the current density associated with the applied electrical potential difference may be at least 1 A/m². In various embodiments, the current density associated with the applied electrical potential difference may be at least 10 A/m². In various embodiments, the current density associated with the applied electrical potential difference may be at least 50 A/m². In various embodiments, the current density associated with the applied electrical potential difference may be at least 100 A/m². In various embodiments, the current density associated with the applied electrical potential difference may be at least 200 A/m². In various embodiments, the current density may be about 0.1 A/m² to about 1 A/m². In various embodiments, the current density may be about 1 A/m² to about 10 A/m². In various embodiments, the current density may be about 10 A/m² to about 50 A/m². In various embodiments, the current density may be about 50 A/m² to about 100 A/m². In various embodiments, the current density may be about 50 A/m² to about 200 A/m². In various embodiments, the current density may be about 100 A/m² to about 200 A/m².

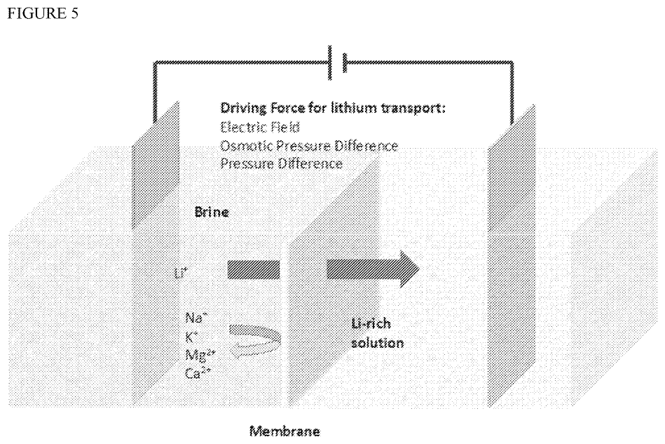

FIG. 5 illustrates an apparatus for excluding lithium using an ion-selective separation membrane. In particular, a driving force (electro-motive, pressure difference, osmotic pressure difference) pulls cations towards the cathode from a brine and such that a Li+-rich solution crosses the membrane, while non-target ions are rejected.

### Examples

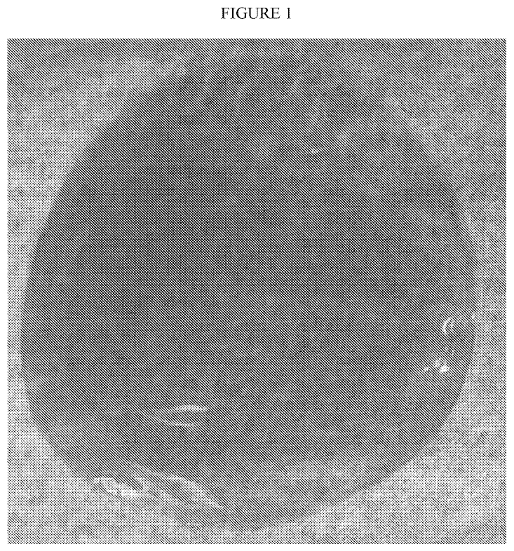

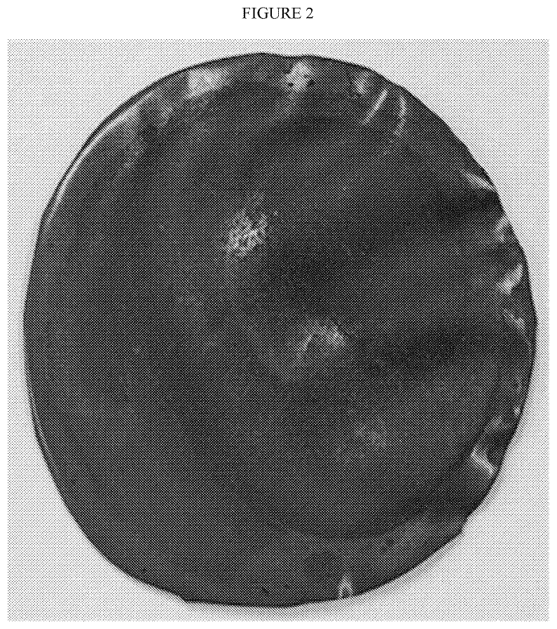

Step 1: Lithium manganese oxide (LMO) was prepared by heat-treating lithium manganese dioxide (LiMnO₂) powder at 450° C. in air. The LMO was delithiated for 24 hours via Li+/H+ ion exchange. 1.5 g of LMO was dispersed in 1.5 L of a strong acid (e.g., 0.5 M HCl) to obtain the lithium adsorbent H_{1.10}Li_{0.08}Mn_{1.73}O_{4.05} (HMO). Then the HMO particle was thoroughly washed with deionized (DI) water until neutral pH was achieved and then dried at 50° C. in the oven.
Step 2: HMO particles were dispersed in an anion exchange polymer solution at a certain mass ratio by sonicating the mixture for 30 seconds in ice bath. Three types of membranes were fabricated with HMO loading of 10%, 25% and 50% (corresponding HMO-polymer ratio of 0.1:1, 0.25:1, 0.5:1).
Step 3: Anion exchange membranes containing HMO (HMO-AEM) were synthesized by evaporating solvent of HMO-polymer mixture at 80° C. in the oven for 20 hours. The prepared HMO-AEM membranes were soaked in testing solution for 24 h and then DI water for 2 h prior to performance tests. FIG. 1 shows the casted AEM without HMO particles. FIG. 2 shows the casted AEM with HMO particles dispersed therein.
Step 4. The HMO-AEM membrane was clamped between two glass diffusion cells. An electrical potential difference was applied as the driving force. The membrane performance was tested under constant current (0.1 A) condition for 75 minutes. The membranes were tested with two types of feed solution: Feed A contains equal molar of Na₂SO₄ (0.017 M), Li₂SO₄ (0.017 M), and MgSO₄ (0.017 M); Feed B contains more common competing cations including Na⁺, K⁺, Ca²⁺ and Mg²⁺ and the cation ratio mimics the ratio in a real geothermal brine (Westmorland). Feed B was prepared such that its ionic strength and sulfate concentration are equivalent to Feed A. That is, 0.003 M of Li₂SO₄, 0.217 M of Na₂SO₄, 0.018 M of K₂SO₄, 0.008 M of CaSO₄, and 0.017 M of MgSO₄.

### Results:

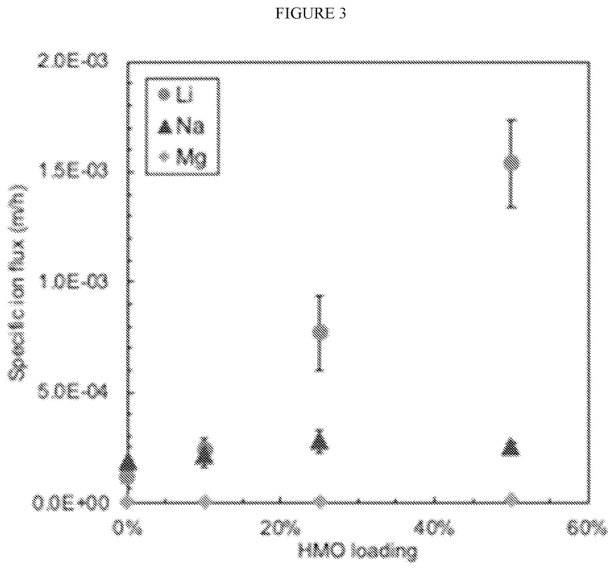

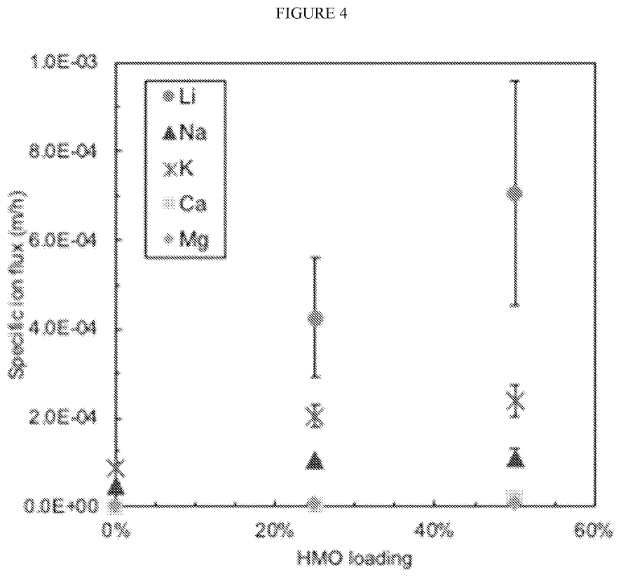

The specific ion flux, calculated from Equation 1, is shown in FIG. 3 (Feed A) and FIG. 4 (Feed B). The ion selectivity is calculated according to Equation 2 and the results are demonstrated in Table 1.

$$Ion specific flux ( m / h ) = \frac{Ion transfer rate ( mol / {m}^{2} \cdot h )}{Initial ion concentration in feed ( mol / L ) \times 1000} \qquad ( 1 )$$

$$( 2 )$$

$$Ion selectivity = \frac{( \frac{Target ion concentration in permeate ( mol / L )}{Target ion concentration in feed ( mol / L )} )}{( \frac{Competing \text{} cation \text{} concentration in permeate \text{} ( mol / L )}{Competing cation concentration in feed ( mol / L )} )}$$

TABLE 1
Ion selectivity for each HMO loading and each feed solution

| Ion | HMO | | | |
|---|---|---|---|---|
| selectivity | loading | | Feed A | Feed B |
| | 0 | Li/Na | 0.6 ± 0.4 | 0.0 ± 0.0 |
| | | Li/K | — | 0.0 ± 0.0 |
| | | Li/Ca | — | ∞ |
| | | Li/Mg | ∞ | ∞ |
| | 25% | Li/Na | 2.8 ± 0.8 | 4.1 ± 1.3 |
| | | Li/K | — | 2.1 ± 0.8 |
| | | Li/Ca | — | ∞ |
| | | Li/Mg | | ∞ |
| | 50% | Li/Na | 6.1 ± 0.9 | 6.2 ± 1.1 |
| | | Li/K | — | 2.9 ± 0.7 |
| | | Li/Ca | — | ∞ |
| | | Li/Mg | ∞ | ∞ |

* ∞ indicates that there was no competing ion flux

What is claimed is:

1. An ion-selective separation membrane comprising:
a polymer matrix;
a metal ion compound dispersed within the polymer matrix;
wherein the metal ion compound comprises HₐLi_{b}X_{c}O_{d}, where a is from 1 to 1.5, b is from 0 to 0.1, c is from 1 to 2, d is from 4 to 4.5, and X comprises manganese or titanium.

2. The ion selective membrane of claim 1, wherein X is manganese or titanium.

3. The ion selective membrane of claim 1 or 2, wherein X is manganese.

4. The ion-selective separation membrane of any one of claims 1-3, wherein b is from greater than 0 to about 0.1.

5. The ion-selective membrane of any one of claims 1-4, wherein the metal ion compound is substantially crystalline.

6. The ion-selective separation membrane of any one of claims 1-5, wherein the polymer matrix comprises an anion exchange polymer.

7. The ion-selective separation membrane of claim 6, wherein the anion exchange polymer comprises a polymer backbone selected from the group consisting of: methacrylamide, polyaromatic, styrene-divinylbenzene copolymer, polyester, poly(vinylchloride), poly(ethylene), poly(propylene), polystyrene, polystyrene-divinylbenzene copolymer, fluorinated interpenetrating polymer network, low density poly(ethylene)/high density poly(ethylene) (interpenetrating polymer network), polystyrene-block-ethylene butylene-block-polystyrene, polystyrene/butadiene, polyethylene oxide, alkoxysilane-functionalized polyethylene oxide, alkoxysilane-functionalized polyvinyl alcohol, poly(epichlorohydrin-co-ethylene oxide), polyvinyl alcohol, poly(epichlorohydrin), polyacrylic acid, chitosan, polybenzimidazole, glycidyl methacrylate, 3-(methacryloxypropyl) trimethoxysilane, alkoxysilane/acrylate, epoxy alkoxysilane, poly(vinylbenzyl chloride), poly(phenylene oxide), poly(methyl acrylate), polyethyleneimine, poly(1,1-dimethyl-3,5-dimethylenepiperidinium chloride), poly(diallyldimethylammonium chloride), poly(allyl amine), poly(acrylonitrile-co-2-dimethylaminoethylmethacrylate), polychloromethylstyrene, poly(divinylbenzene), norbonene/dicyclopentadiene, cyclooctene, poly(phenylene), poly(methyl methacrylate), poly(butyl-acrylate), poly(methyl methacrylate-co-butyl-acrylate-co-vinyl benzyl), polyvinyl butyral, polyvinylidene fluoride, ethylene tetrafluoroethylene, fluorinated ethylene propylene, polytetrafluoroethylene, poly(4-vinylpyridine), polystyrene-ethylene-butylene sulfonate copolymer, epichlorohydrin/1,4-diazabicyclo[2.2.2]octane, polyethylene glycol, polysulfone, polyethersulfone Cardo, poly(phthalazinone ether sulfone ketone), polysulfonepolyphenylenesulfidesulfone, polyarylene, polydiallyldimethylammonium chloride, poly(ether imide), and sulfonated tetrafluoroethylene based fluoropolymer-copolymer.

8. The ion-selective separation membrane of claim 6 or 7, wherein the anion exchange polymer comprises a functional group selected from the group consisting of: quaternary ammonium, a tertiary diamine, (benz) imidazolium, guanidinium, and pyridinium.

9. The ion selective membrane of claim 6 or 7, wherein the anion exchange polymer comprises a functional group that does not comprise nitrogen.

10. The ion-selective separation membrane of any one of claims 6-9, wherein the anion exchange polymer comprises a functional group selected from the group consisting of phosphonium, sulphonium, ruthenium, nickel, and cobalt.

11. The ion-selective separation membrane of any one of claims 1-10, wherein, X is manganese, a is about 1.10, b is about 0.08, c is about 1.73, d is about 4.05.

12. The ion-selective separation membrane of any one of claims 1-11, further comprising a plurality of embedded ionic particles.

13. A method of preparing an ion-selective separation membrane, the method comprising:
providing a lithium manganese oxide or a lithium titanium oxide;
delithiating the lithium manganese oxide or the lithium titanium oxide to obtain a lithium adsorbent;
dispersing the lithium adsorbent in a polymer matrix to form a polymer-adsorbent mixture; and
heating the polymer-adsorbent mixture to thereby obtain the synthesized ion-selective separation membrane.

14. The method of claim 13, wherein delithiating is performed via a Li⁺/H⁺ ion exchange.

15. The method of claim 13 or claim 14, wherein delithiating is performed for at least 24 hours.

16. The method of any one of claims 13-15, wherein delithiating comprises mixing the lithium manganese oxide or the lithium titanium oxide after the Li⁺/H⁺ ion exchange with a dispersion solution.

17. The method of claim 16, wherein the dispersion solution comprises an acid.

18. The method of claim 17, wherein the acid comprises hydrochloric acid.

19. The method of any one of claims 16-18, wherein delithiating comprises washing the lithium manganese oxide or the lithium titanium oxide with a washing solution after mixing with the dispersion solution.

20. The method of claim 19, wherein the washing solution comprises deionized water.

21. The method of claim 19 or 20, wherein washing is performed until a neutral pH of the lithium adsorbent is obtained.

22. The method of any one of claims 13-21, wherein delithiating further comprises drying the lithium adsorbent.

23. The method of claim 13, wherein providing lithium manganese oxide comprises heating a lithium manganese dioxide.

24. The method of claim 23, wherein heating is performed at a temperature of about 350° C. to about 600° C.

25. The method of claim 24, wherein the temperature is about 450° C.

26. The method of claim 24 or 25, wherein heating is performed in air.

27. The method of claim 13, wherein heating the polymer-adsorbent mixture evaporates a solvent of the mixture.

28. The method of claim 13, wherein the synthesized ion-selective separation membrane comprises a ratio of lithium adsorbent to polymer matrix of about 1:99 to about 2:1.

29. The method of claim 13, wherein the synthesized ion-selective separation membrane comprises a ratio of lithium adsorbent to polymer matrix of about 1:19 to about 2:1.

30. The method of claim 13, wherein the synthesized ion-selective separation membrane comprises a ratio of lithium adsorbent to polymer matrix of about 1:3 to about 2:1.

31. A method of selectively separating ions in a polar solution comprising a plurality of ions, the method comprising:
providing an ion-selective separation membrane of any one of claims 1-12;
contacting the polar solution with the ion-selective separation membrane;
applying an electrical potential difference across the ion-selective separation membrane to selectively transport target ions through the membrane.

32. The method of claim 31, wherein the target ions comprise Lit ions.

33. The method of claim 31, wherein the plurality of ions comprises at least one of the following: Na⁺, K⁺, Ca²⁺, and Mg²⁺.

34. The method of claim 31, wherein the electrical potential difference is from about 1 V to about 50 V.

35. The method of claim 31, wherein a current associated with the electrical potential difference is from about 0.01 A to about 0.5 A.

36. The method of claim 31, wherein a current associated with the electrical potential difference is about 0.1 A.

37. The method of any one of claims 31-36, wherein the polar solution comprises a continental brine, a geothermal brine, an oil field brine, a leachate from mining operations, a leachate from battery recycling operations, or any other leachate containing target ions for separation.

38. The method of any one of claims 31-37, wherein the method is continuous.

39. An ion-selective separation membrane comprising:
a polymer matrix having a polymer backbone and one or more functional groups;
a metal ion adsorbent dispersed within the polymer matrix, wherein the metal ion adsorbent is configured to allow transport a target ion through the membrane and block passage of one or more non-target ions upon application of an electric potential difference across the membrane.
